(19) United States
(12) Patent Application Publication
(10) Pub. No.: US 2014/0204225 A1
(43) Pub. Date: Jul. 24, 2014

(54) IMAGE PROCESSING APPARATUS, IMAGE PROCESSING METHOD, PROGRAM, AND DISPLAY DEVICE

(71) Applicant: SONY CORPORATION, TOKYO (JP)

(72) Inventor: YUUJI TAKIMOTO, Kanagawa (JP)

(73) Assignee: SONY CORPORATION, TOKYO (JP)

(21) Appl. No.: 14/150,368

(22) Filed: Jan. 8, 2014

(30) Foreign Application Priority Data
Jan. 21, 2013 (JP) 2013-008361

(51) Int. Cl. H04N 5/232

(52) U.S. Cl. CPC H04N 5/23222
USPC 348/207.1

(57) ABSTRACT

There is provided an image processing apparatus including an image acquisition section configured to acquire a captured image including a plurality of two-dimensional codes and a plurality of images corresponding to each of the two-dimensional codes, an address information extraction section configured to recognize each of the two-dimensional codes from the captured image, and to extract information showing addresses on a network from each of the two-dimensional codes, an image extraction section configured to extract each of the images from the captured image, and a display control section configured to allow a display section to display a link to each of the addresses in association with each of the images.

### CROSS REFERENCE TO RELATED APPLICATIONS

This application claims the benefit of Japanese Priority Patent Application JP 2013-008361 filed Jan. 21, 2013, the entire contents of which are incorporated herein by reference.

### BACKGROUND

The present disclosure relates to an image processing apparatus, an image processing method, a program, and a display device.

In recent years, reading a URL (Uniform Resource Locator) from a two-dimensional code included in a captured image, and obtaining information by accessing an address shown by the URL, has become common as a simple access mechanism to information. For example, JP 2004-287592A discloses technology in which a URL of a website is embedded in a two-dimensional code printed on an advertising medium for purchasing products appearing in the advertising medium, and the website is accessed by reading the URL from an image capturing this advertising medium by a mobile phone.

### SUMMARY

In the technology disclosed in JP 2004-287592A, a user selects a target two-dimensional code himself or herself, and performs imaging by bringing a camera close to this two-dimensional code, such as shown in FIG. 1, for example. In this way, access to a website using the URL read from the two-dimensional code is implemented with a minimal amount of operations. However, in the case where a user has an interest in multiple products appearing in an advertising medium, for example, it may be necessary to repeat imaging of the two-dimensional code and accessing to the website at once for the number of products, and this may not be necessarily convenient.

Accordingly, the present disclosure proposes a new and improved image processing apparatus, image processing method, program, and display device in which accessing a plurality of addresses via two-dimensional codes is made easy.

According to an embodiment of the present disclosure, there is provided an image processing apparatus including an image acquisition section configured to acquire a captured image including a plurality of two-dimensional codes and a plurality of images corresponding to each of the two-dimensional codes, an address information extraction section configured to recognize each of the two-dimensional codes from the captured image, and to extract information showing addresses on a network from each of the two-dimensional codes, an image extraction section configured to extract each of the images from the captured image, and a display control section configured to allow a display section to display a link to each of the addresses in association with each of the images.

According to an embodiment of the present disclosure, there is provided an image processing method including acquiring a captured image including a plurality of two-dimensional codes and a plurality of images corresponding to each of the two-dimensional codes, recognizing each of the two-dimensional codes from the captured image, and extracting information showing addresses on a network from each of the two-dimensional codes, extracting each of the images from the captured image, and allowing a display section to display a link to each of the addresses in association with each of the images.

According to an embodiment of the present disclosure, there is provided a program for causing a computer to execute the functions of acquiring a captured image including a plurality of two-dimensional codes and a plurality of images corresponding to each of the two-dimensional codes, recognizing each of the two-dimensional codes from the captured image, and extracting information showing addresses on a network from each of the two-dimensional codes, extracting each of the images from the captured image, and allowing a display section to display a link to each of the addresses in association with each of the images.

According to an embodiment of the present disclosure, there is provided a display device including a display control section configured to allow a display section to display a plurality of two-dimensional codes in which information showing addresses on a network is embedded, and a plurality of images corresponding to each of the two-dimensional codes, and a control signal reception section configured to receive, from an image processing apparatus which recognizes each of the two-dimensional codes and the images from a captured image including the plurality of two-dimensional codes and the plurality of images, a control signal sent in accordance with a state of the captured image or a recognition result of the two-dimensional codes or the images. The display control section controls a display of the plurality of two-dimensional codes and the plurality of images in accordance with the control signal.

By recognizing a plurality of two-dimensional codes from a captured image, extracting information which shows addresses on a network from each of the two-dimensional codes, and allowing the extracted information to be displayed as links, accessing a plurality of addresses via each of the two dimensional codes becomes easy for a user. Further, in this case, by recognizing images corresponding to each of the two-dimensional codes from the captured image, and displaying the recognized images in association with the links, a user can easily comprehend the content capable of being accessed by each of the links.

According to the embodiments of the present disclosure such as described above, accessing a plurality of addresses via two-dimensional codes can be made easy.

### BRIEF DESCRIPTION OF THE DRAWINGS

FIG. 1 is a figure which shows a schematic configuration of a first embodiment of the present disclosure;

FIG. 2 is a figure which shows a schematic configuration of the first embodiment of the present disclosure;

FIG. 3 is a figure which shows an example of a display after imaging in the first embodiment of the present disclosure;

FIG. 4 is a figure which shows an example of scrolling and consecutively photographing a display image in the first embodiment of the present disclosure;

FIG. 5 is a block diagram which shows a schematic functional configuration of an image processing apparatus according to the first embodiment of the present disclosure;

FIG. 6 is a block diagram which shows a schematic functional configuration of a display device according to the first embodiment of the present disclosure;

FIG. 7 is a flow chart which shows an example of a process flow of the image processing apparatus in the first embodiment of the present disclosure;

FIG. 8 is a flow chart which shows another example of a process flow in the first embodiment of the present disclosure;

FIG. 9 is a figure which shows a schematic configuration of a second embodiment of the present disclosure;

FIG. 10 is a figure which shows a schematic configuration of a third embodiment of the present disclosure;

FIG. 11 is a figure which shows a schematic configuration of a fourth embodiment of the present disclosure; and

FIG. 12 is a block diagram for describing a hardware configuration of an information processing apparatus.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will be given in the following order.

1. Outline

2. Functional configuration

2-1. Functional configuration of the image processing apparatus

2-2. Functional configuration of the display device

3. Process flow

4. Other embodiments

5. Hardware configuration

6. Supplemental Remarks

### 1. Outline

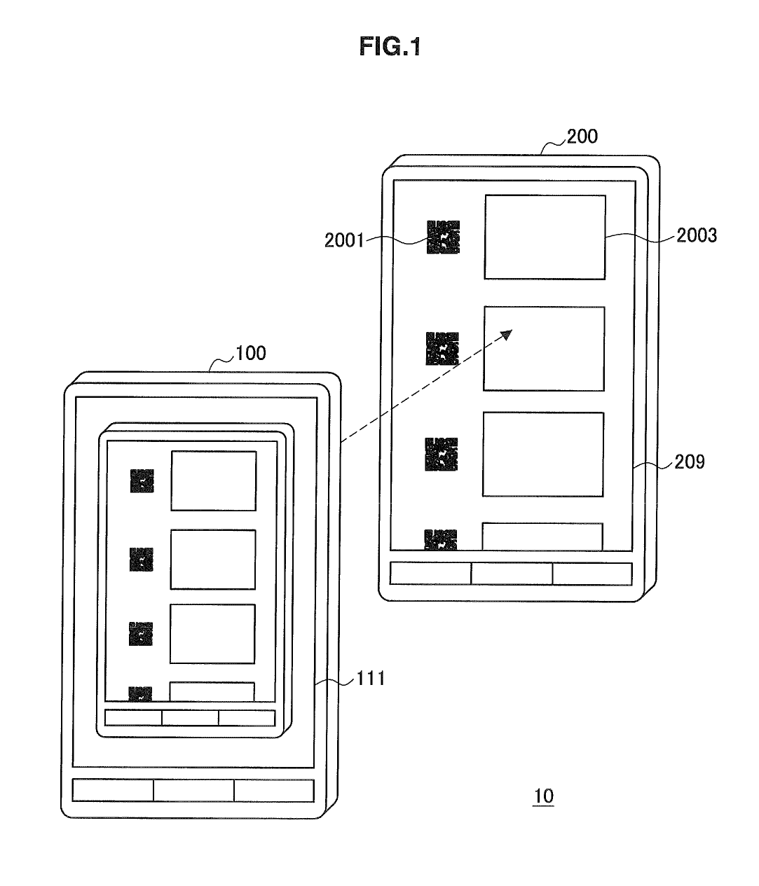

First, an outline of a first embodiment of the present disclosure will be described by referring to FIGS. 1 to 4.

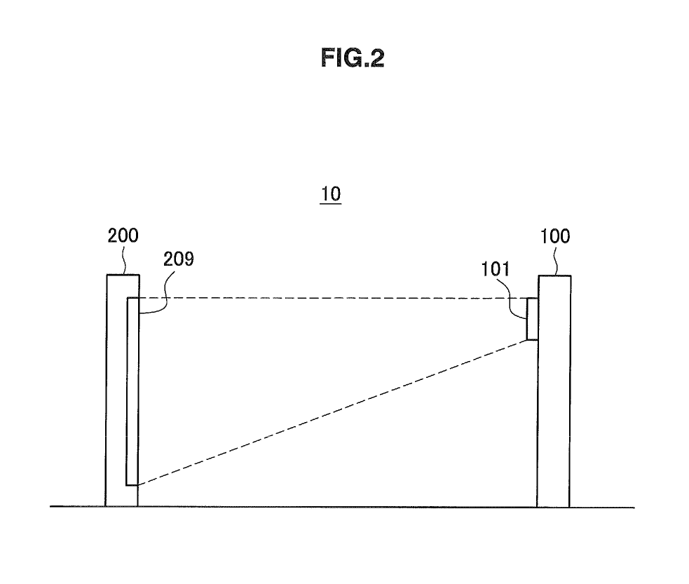

FIGS. 1 and 2 are figures which show a functional configuration of the first embodiment of the present disclosure. With reference to FIGS. 1 and 2, a system 10 includes two mobile phones 100 and 200. The mobile phone 100 includes a camera 101, and captures images which include an image displayed on a display 209 of the mobile phone 200. FIG. 1 shows a state in which an image of the mobile phone 200 captured by the camera 101 is displayed on a display 111 of the mobile phone 100 as a through image. Further, FIG. 2 shows a state in which the display 209 of the mobile phone 200 is included in the angle of view of the camera 101 of the mobile phone 100. As shown in FIG. 2, in order to maintain a position relation between the camera 101 and the display 209, the mobile phones 100 and 200 may be aligned by being placed on the same desk, for example.

The image displayed on the display 209 of the mobile phone 200 includes two-dimensional codes 2001 and images 2003. Here, a URL is embedded in each of the two-dimensional codes 2001. The images 2003 display the content of the addresses shown by these URLs. As a specific example, a URL of an image file stored in an online storage may be embedded in a two-dimensional code 2001, and an image 2003 may be a thumbnail of an image displayed by the image file. Or, a URL of a shopping site may be embedded in a two-dimensional code 2001, and an image 2003 may be an image which shows a logo or the products of the shopping site. Further, an image 2003 may include a two-dimensional code for displaying additional information, which will be described later.

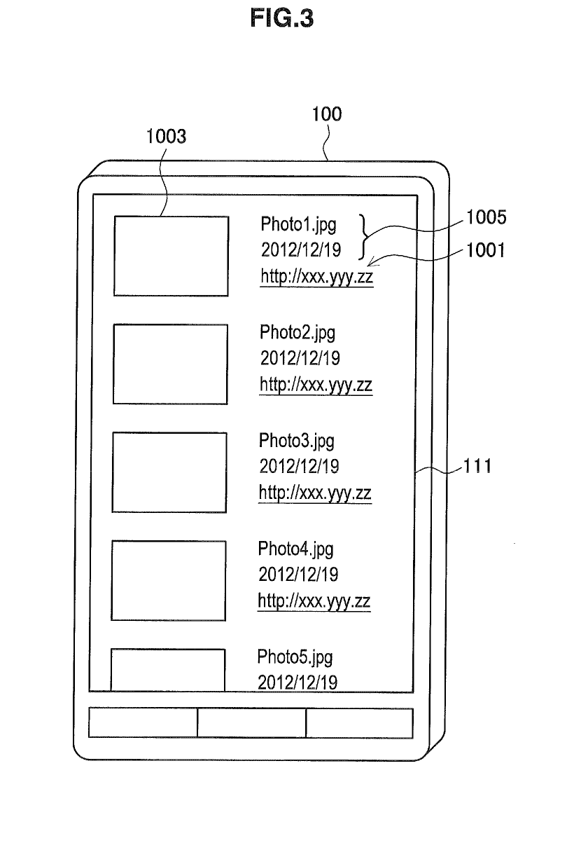

FIG. 3 is a figure which shows an example of a display after imaging in the first embodiment of the present disclosure. With reference to FIG. 3, an image which includes an image displayed on the display 209 of the mobile phone 200 such as shown in FIG. 1 and FIG. 2 is captured, and thereafter an image which includes links 1001 and images 1003 is displayed on the display 111 of the mobile phone 100. The image may also include additional information 1005.

The links 1001 are links to URLs embedded in the two-dimensional codes 2001 displayed on the display 209 of the mobile phone 200. By selecting one of the links 1001 via an operation section such as a touch panel of the mobile phone 100, it is possible to access an address shown by a URL. For example, by selecting a link 1001, if using an example of an online storage or a shopping site such as described above, an image file stored in the online storage can be acquired, or the shopping site can be accessed.

The images 1003 are images similar to the images 2003 displayed on the display 209 of the mobile phone 200. As described above, the images 2003 display the content of the addresses shown by the URLs embedded in the two-dimensional codes 2001. Therefore, the images 1003 display the content of link destinations of the links 1001. By displaying the images 1003, a user can easily understand the content of a link destination at the time when one of the links 1001 is selected.

The additional information 1005 displays information related to the content of the link destinations of the links 1001 along with images 1003. In the illustrated example, since the links 1001 are URLs of image files, a file name and a date of capturing an image are displayed as the additional information 1005. The additional information 1005 may be displayed based on information embedded in the two-dimensional codes 2001 along with the URLs, for example. Further, the additional information 1005 may be read from two-dimensional codes included in the images 2003.

In this way, the links 1001 and images 1003 are displayed on the display 111 of the mobile phone 100, and by also displaying additional information 1005 as necessary, it is possible to individually or collectively access a plurality of addresses read from a plurality of the two-dimensional codes 2001 displayed as a list, and useful information can be provided upon selecting an address which a user accesses. By retaining information for displaying the links 1001 and images 1003 in the mobile phone 100, imaging can be performed once, and thereafter it is possible to continuously access the link destinations of each of the links 1001, even if the mobile phone 100 and the mobile phone 200 are separated from each another.

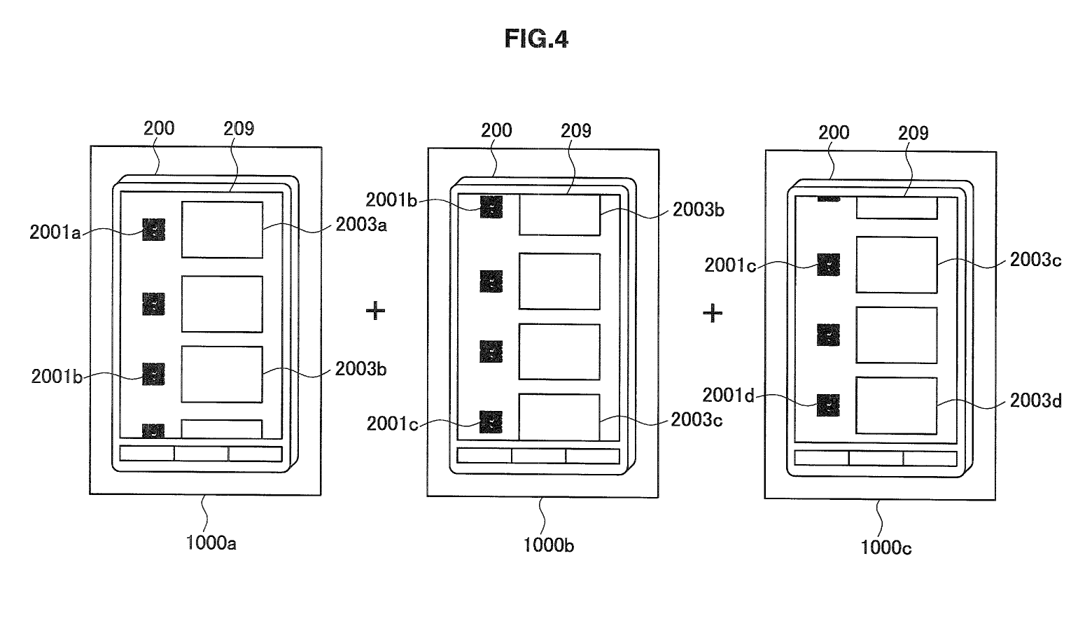

FIG. 4 is a figure which shows an example of scrolling and consecutively photographing a display image in the first embodiment for the present disclosure. With reference to FIG. 4, images displayed on the display 209 of the mobile phone 200 are projected on each of the captured images 1000a to 1000c. Here, the captured images 1000a to 1000c are a series of images captured at prescribed intervals, and a process is reflected in which the images displayed on the display 209 are sequentially scrolled.

More specifically, a two-dimensional code 2001a and an image 2003a projected on the top part of the display 209 in the captured image 1000a disappear from the display 209 in the captured image 1000b. On the other hand, a two-dimensional code 2001b and an image 2003b displayed on the lower part of the display 209 in the captured image 1000a deviate from the top part of the display 209 in the captured image 1000b. From this, it is understood that a display of the display 209 is scrolling between the captured image 1000a and the captured image 1000b. Similarly, a two-dimensional code 2001c and an image 2003c only appearing from the lower part of the display 209 in the captured image 1000b will be displayed in the upper part of the display 209 in the captured image 1000c. Further, a two-dimensional code 2001d and an image 2003d not displayed up to here will be displayed in the lower part of the display 209 in the captured image 1000c.

In this way, the mobile phone 200 allows a display of two-dimensional codes 2001 and images 2003 on the display 209 to be scrolled, and by having the camera 101 of the mobile phone 100 consecutively photograph images which include the display 209 during scrolling, a large number of two-dimensional codes 2001 and images 2003 capable of being displayed once on the display 209 can be read.

### 2. Functional Configuration

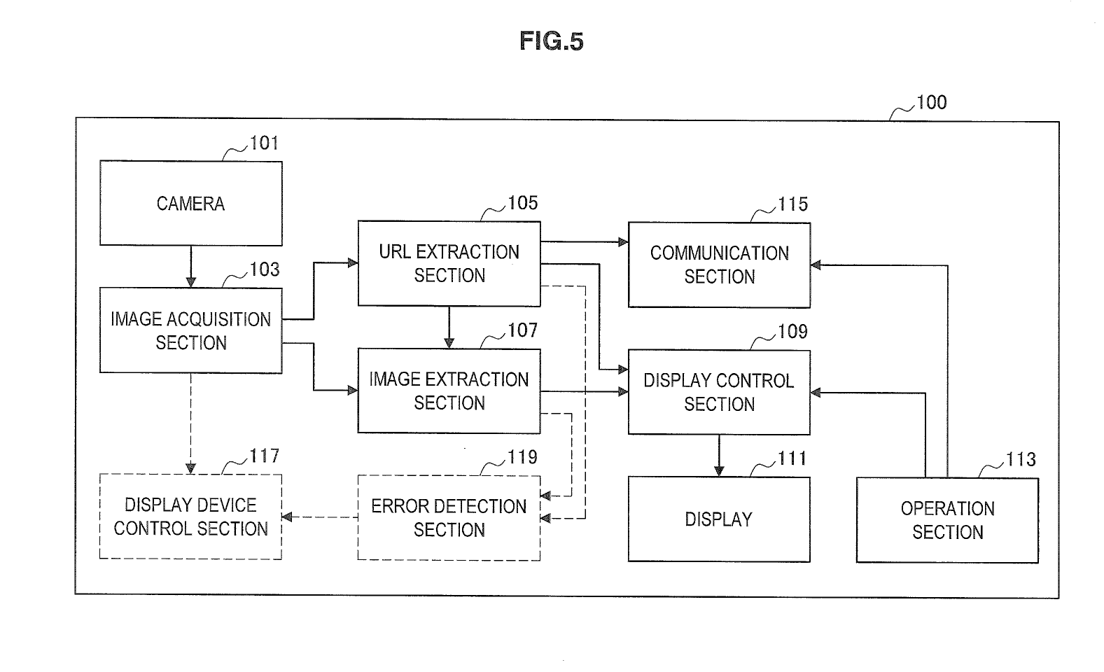

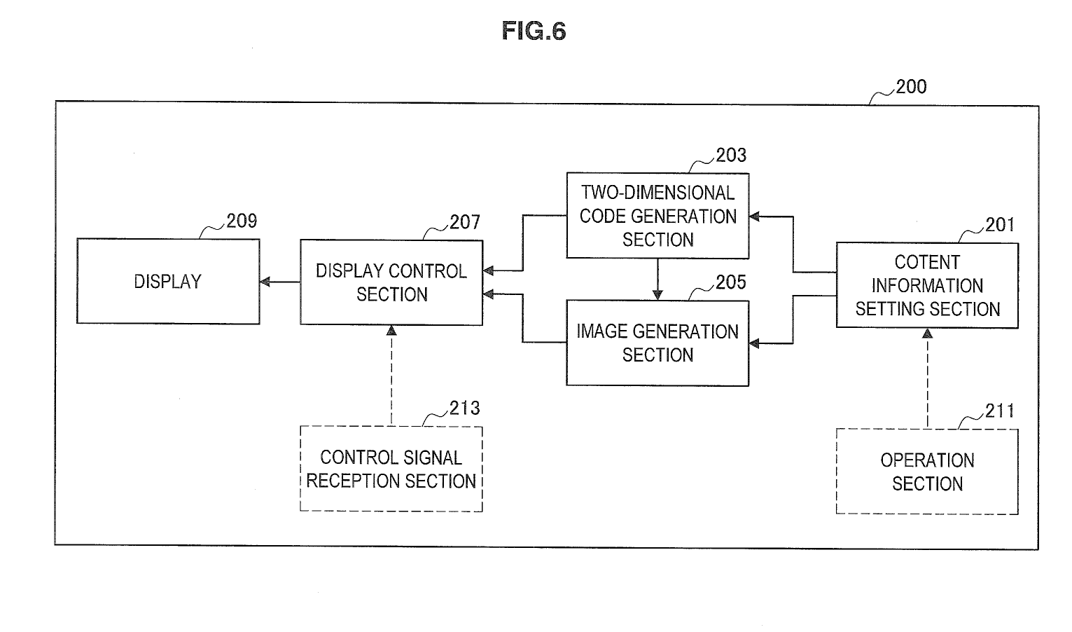

Next, a functional configuration of the first embodiment of the present disclosure will be described by referring to FIGS. 5 and 6.

(2-1. Functional Configuration of the Image Processing Apparatus)

FIG. 5 is a block diagram which shows a schematic functional configuration of an image processing apparatus according to an embodiment of the present disclosure. With reference to FIG. 5, the mobile phone 100 includes a camera 101, an image acquisition section 103, a URL extraction section 105, an image extraction section 107, a display control section 109, a display 111, an operation section 113, and a communication section 115. The mobile phone 100 may additionally include a display device control section 117 and/or an error detection section 119.

The mobile phone 100 may be implemented, for example, by a hardware configuration of an information processing apparatus, which will be described later. In this case, each section other than the camera 101, the display 111, the operation section 113 and the communication section 115 may be implemented, for example, by software by using a processor such as a CPU (Central Processing Unit).

Note that, in the present embodiment, the mobile phone 100 functions as an image processing apparatus, which acquires a captured image, and allows links and images to be displayed by processing this image. Therefore, in the description of the present embodiment, the mobile phone 100 will be treated as an example of an image processing apparatus.

The image acquisition section 103 acquires an image captured by the camera 101 (an imaging section). As described above, a plurality of two-dimensional codes 2001 displayed on the display 209 of the mobile phone 200, and a plurality of images 2003 corresponding to each of the two-dimensional codes 2001, are included in the image captured by the camera 101. The image acquisition section 103 provides the acquired image to the URL extraction section 105 and the image extraction section 107. Further, the image acquisition section 103 may provide the acquired image to the display device control section 117.

As shown in the above described example of FIG. 4, in the case where the camera 101 consecutively photographs captured images, the image acquisition section 103 acquires a plurality of captured images obtained by continuously imaging the display 209 of the mobile phone 200, on which two-dimensional codes 2001 and images 2003 are displayed while being scrolled. In this case, the image acquisition section 103 may provide the plurality of captured images combined together to the URL extraction section 105 and the image extraction section 107. Note that, it is possible to use the various technologies disclosed in JP 2012-109863A, for example, for the combination of the plurality of captured images. Or, the image acquisition section 103 may provide the plurality of captured images as they are to the URL extraction section 105 and the image extraction section 107, and the URL extraction section 105 and the image extraction section 107 may exclude the recognized two-dimensional codes, or extracted URLs, and the recognized images which are overlapping.

The URL extraction section 105 recognizes the two-dimensional codes 2001 from the image acquired by the image acquisition section 103, and extracts URLs from the recognized two-dimensional codes 2001. Note that, a URL is an example of information which displays an address on a network. The URL extraction section 105 provides the extracted URLs to the display control section 109 and the communication section 115.

The image extraction section 107 recognizes the images 2003 from the image acquired by the image acquisition section 103. The images 2003 correspond to each of the two-dimensional codes 2001, and are displayed on the display 111 as images 1003 corresponding to links 1001 to the addresses shown by the URLs extracted from the two-dimensional codes 2001, which will be described later. For example, the image extraction section 107 recognizes the images 2003 corresponding to the URLs extracted by the URL extraction section 105. Specifically, for example, the image extraction section 107 acquires position information within the image of one of the recognized two-dimensional codes 2001 from the URL extraction section 105, specifies a recognized image at a position nearest to the two-dimensional code 2001 as an image 2003 corresponding to this two-dimensional code 2001, and extracts an image 1003 by cutting the region of the image 2003 from the captured image.

The display control section 109 allows the display 111 (display section) to display a link 1001, which is the link to the address shown by the URL extracted from the two-dimensional code 2001 by the URL extraction section 105, mutually associated with the image 1003 recognized by the image extraction section 107.

The operation section 113 receives an operation of a user who observes the links 1001 and images 1003 displayed on the display 111. In the present embodiment, the operation section 113 is implemented by a touch panel of the mobile phone 100. Since the image processing apparatus according to an embodiment of the present disclosure is not limited to a mobile phone as will be described later, the operation section 113 in the other embodiments may be various types of input apparatuses, such as a mouse or a keyboard. For example, the operation section 113 may acquire an operation of a user who selects one or a plurality of links from among the links 1001 displayed on the display 111.

The communication section 115 performs access to the link destination of the link 1001 selected by the user, by communication via a network. As described above, the URL of the link destination is extracted from the two-dimensional code 2001 included in the captured image by the URL extraction section 105. The communication section 115 may be implemented by various types of communication apparatuses capable of performing network communication.

The display device control section 117 communicates with the mobile phone 200 which functions as a display device, and controls a display of two-dimensional codes 2001 and images 2003 on the display 209, in accordance with a state of the captured image acquired by the image acquisition section 103, or a recognition result of the two-dimensional codes or images notified from the error detection section 119. For example, in the case where blurring, a deviation of focus, or a reflection of an obstacle such as a finger of a user is detected in the captured image acquired by the image acquisition section 103, and it is estimated that correctly recognizing the two-dimensional codes 2001 or images 2003 will be difficult, the display device control section 117 communicates with the mobile phone 200 via the communication apparatus, and may indirectly control a display of the display 209. In this case, for example, the display device control section 117 may control the display position or size of the two-dimensional codes 2001 and images 2003 displayed on the display 209. In the case where an error occurring in the recognition of the two-dimensional codes or images is detected by the error detection section 119, the display device control section 117 may similarly indirectly control a display of the display 209. Note that, for example, control signals for controlling the display device by the display device control section 117 may be transmitted to the mobile phone 200 by peer-to-peer communication, such as Bluetooth (registered trademark) or Wi-Fi.

Further, as described above in the example of FIG. 4, in the case where the mobile phone 200 allows a display of the display 209 to be scrolled, and the camera 101 consecutively photographs captured images, the display device control section 117 detects blurring, a deviation of focus, or a reflection of an obstacle such as a finger of a user for each of a plurality of captured images acquired by the image acquisition section 103 by consecutively photographing, and in the case where these are detected, the display device control section 117 may indirectly control a display of the display 209. In this case, for example, the display device control section 117 may control the display position or size of the two-dimensional codes 2001 and images 2003 displayed on the display 209, may adjust the speed of scrolling, and may return the scrolling position. This is the same for the case where an error of recognition actually occurring is detected by the error detection section 119. Further, the display device control section 117 may perform a command so that the scrolling of the display starts in the mobile phone 200, at the time when preparations of imaging by the camera 101 (such as an adjustment of angle or focus) are completed.

The error detection section 119 detects that an error has occurred in the recognition of two-dimensional codes or extraction of URLs in the URL extraction section 105, or in the recognition of images in the image extraction section 107. For example, the URL extraction section 105 may specify a region in which a two-dimensional code 2001 exists within the captured image, and may extract a URL by reading the image of this region as a two-dimensional code. In this case, if there is a state in which reading is difficult, due to a missing part of the image of the specified region or blurring of the image, an error of recognition may be detected by the error detection section 119. Further, for example, the image extraction section 107 may specify a region at which it is estimated that an image 2003 exists within the captured image, and may extract an image of this region as an image 1003. In this case, if there is a missing part of the image of this region or if the image is blurred when the region is specified, an error of recognition may be detected by the error detection section 119.

Further, for example, the number of two-dimensional codes 2001 and images 2003 read from the captured image may be notified to the error detection section 119 in advance, by another two-dimensional code displayed at a prescribed position of the display 209 or by a user operation. In this case, if the number of URL extracted by the URL extraction section 105 is a different prescribed number from the number of images recognized by the image extraction section 107, the error detection section 119 may determine that an error of recognition has occurred. Further, in the case where an image corresponding to a URL has not been extracted, or in the case where a URL corresponding to an image has not been extracted, the error detection section 119 may determine that an error has occurred. Or, in the case where the number of extracted URLs is different to the number of images, the error detection section 119 may determine that an error has occurred.

For example, in the case where an error of recognition has occurred, the error detection section 119 may indirectly control a display of the display 209 by making a request to the display device control section 117, and may allow the acquisition of captured images to be performed again by the camera 101 in a state in which an error is less likely to occur. Further, for example, as described above in the example of FIG. 4, in the case where the mobile phone 200 allows a display of the display 209 to be scrolled, and the camera 101 consecutively photographs captured images, the error detection section 119 may indirectly control a display of the display 209 by making a request to the display device control section 117, and may allow scrolling to start over and the speed of the scrolling after this to be adjusted, for the portion in which an error of recognition has occurred.

Or, in the case where the display device acquisition section 117 is not included, the error detection section 119 may simply allow the acquisition of captured images to be performed again by the camera 101 (for example, there is the possibility that an error will be resolved by starting auto focusing again or the like), and may notify the occurrence of an error to a user (there is the possibly that an error will be resolved by having the user adjust the position of the mobile phone 100 or the like).

(2-2. Functional Configuration of the Display Device)

FIG. 6 is a block diagram which shows a schematic functional configuration of a display device according to the first embodiment of the present disclosure. With reference to FIG. 6, the mobile phone 200 includes a content information setting section 201, a two-dimensional code generation section 203, an image generation section 205, a display control section 207, and a display 209. The mobile phone 200 may additionally include an operation section 211 and/or a control signal reception section 213.

The mobile phone 200 may be implemented, for example, by a hardware configuration of an information processing apparatus, which will be described later. In this case, each section other than the display 209 and the operation section 211 may be implemented, for example, by software by using a processor such as a CPU.

Note that, in the present embodiment, the mobile phone 200 functions as a display device, which allows two-dimensional codes and images corresponding to these two-dimensional codes to be displayed. Therefore, in the description of the present embodiment, the mobile phone 200 will be treated as an example of a display device.

The content information setting section 201 sets information of contents based on the two-dimensional codes 2001 and images 2003 displayed on the display 209. For example, a URL of an image file stored in an online storage may be embedded in one of the two-dimensional codes 2001, and an image 2003 may be a thumbnail of an image displayed by the image file. In this case, the content information setting section 201 may set this image file, and the URL acquired at the time when the image file is uploaded to the online storage via a communication section, which is not shown in the mobile phone 200, as content information. The content information setting section 201 provides the set content information to the two-dimensional code generation section 203 and the image generation section 205.

Further, the content information setting section 201 may set the content information based on an operation of a user acquired by the operation section 211, such as a touch panel of the mobile phone 200. For example, a URL of a shopping site may be embedded in one of the two-dimensional codes 2001, and an image 2003 may be an image which shows a logo or the products of the shopping site. In this case, the content information setting section 201 may set a URL or an image prepared in advance as content information based on an operation of a user acquired by the operation section 211.

The two-dimensional code generation section 203 generates two-dimensional codes by encoding, in a prescribed form, the URLs included in the content information set by the content information setting section 201. For example, while a QR code (registered trademark) may be used as the form of the two-dimensional codes, other forms may also be used. The generated two-dimensional codes are displayed on the display 209 as the two-dimensional codes 2001.

The image generation section 205 generates the images 2003 from the images included in the content information set by the content information setting section 201. While there are cases where it is possible to use the images included in the content information as the images 2003 as they are (in this case, the image generation section 205 does not perform substantial processes), in the case where an image file is uploaded to the online storage, for example, the image generation section 205 may reduce the image, in order to allow a thumbnail of the image displayed by the image file to be displayed as one of the images 2003.

Here, as described above, the images 2003 are recognized as images corresponding to the two-dimensional codes 2001, in the captured images which include an image displayed on the display 209. Therefore, for example, the image generation section 205 specifies display positions of the generated images 2003, so that a position relation with the two-dimensional codes 2001 satisfies a prescribed condition. For example, the image generation section 205 may specify display positions of the image 2003s, so that the generated images 2003 are displayed at positions nearest to the corresponding two-dimensional codes 2001.

The display control section 207 allows the two-dimensional codes 2001 generated by the two-dimensional code generation section 203, and the images 2003 generated by the image generation section 205, to be displayed on the display 209 (a display section). As described above, the two-dimensional codes 2001 and the images 2003 may be expressed, for example, by having a prescribed position relation.

In the case where the display device control section 117 is included in the mobile phone 100, the control signal reception section 213 may be included so as to correspond to this. The control signal reception section 213 controls the display control section 207, based on control signals received from the display device control section 117. In this way, for example, the display positions or sizes of the two-dimensional codes 2001 and images 2003 displayed on the display 209 may be changed. Further, as shown in the above described example of FIG. 4, in the case where the mobile phone 200 allows a display of the display 209 to be scrolled and the camera 101 consecutively photographs captured images, the scrolling speed may be adjusted and the scrolling position may be returned at the time when the display control section 207 allows a display of the display 209 to be scrolled, based on the control signals received by the control signal reception section 213. Further, scrolling of a display of the display 209 may be started, based on the control signals received by the control signal reception section 213.

3. Process Flow

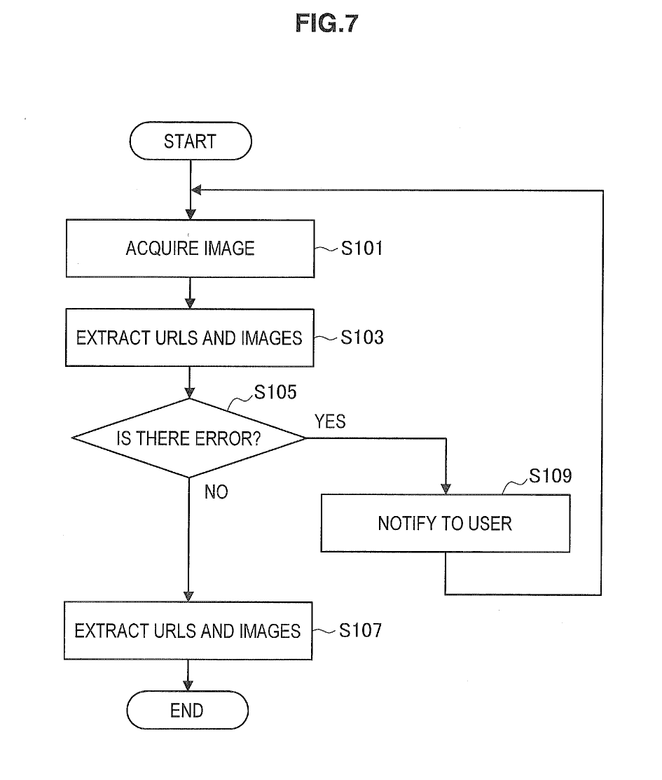

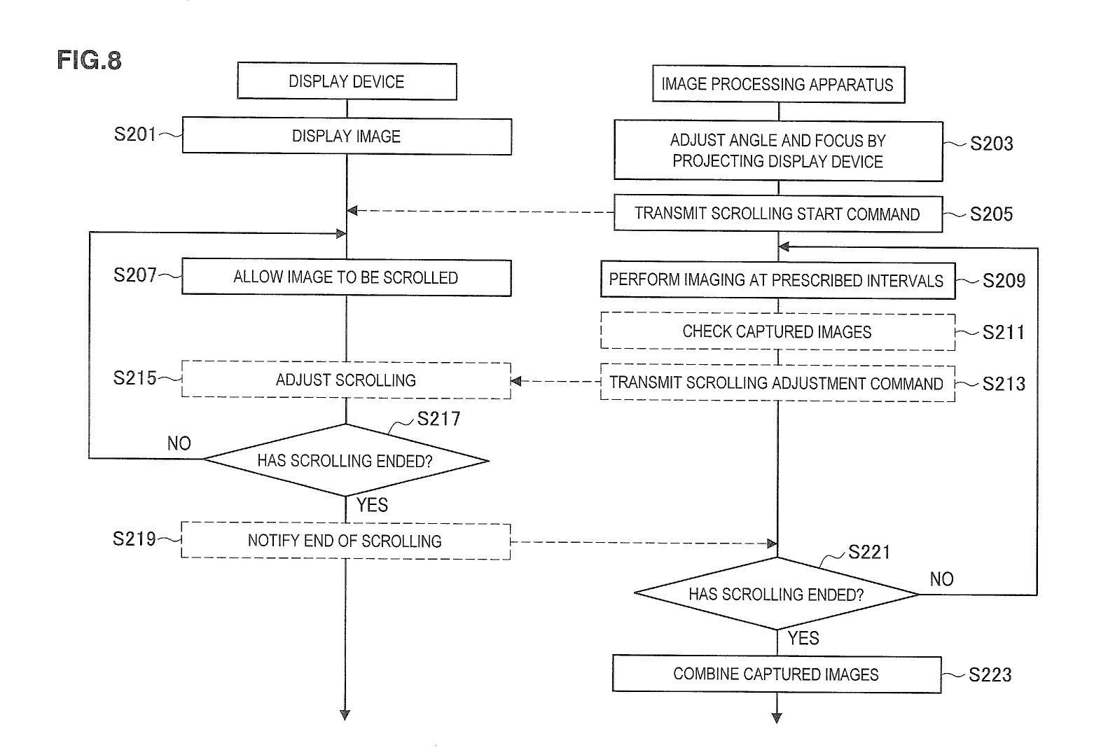

Next, a process flow in the first embodiment of the present disclosure will be described by referring to FIGS. 7 and 8.

FIG. 7 is a flow chart which shows an example of a process flow of the image processing apparatus in the first embodiment of the present disclosure. In the example shown in FIG. 7, the error detection section 119 is included in the mobile phone 100, and the display device control section 117 is not included.

First, the image acquisition section 103 acquires an image captured by the camera 101 (step S101). Next, the URL extraction section 105 and the image extraction section 107 extract URLs and images from the acquired image (step S103). Here, the error detection section 119 determines whether or not an error has occurred in the extraction of the URLs and images (step S105). The occurrence of an error may be detected, for example, based on a missing region of the image, blurring of the image, or the number of extracted URLs and images.

In the case where it is determined in step S105 that an error has occurred, the error detection section 119 notifies a user of this fact (step S109). The user who receives the notification performs imaging again, upon adjusting the position of the mobile phone 100, for example (step S101). On the other hand, in the case where it is determined in step S105 that an error has not occurred, the extracted URLs and images are provided to the display control section 109, and an image which includes links 1001 and images 1003 is displayed on the display 111 (step S107).

FIG. 8 is a flow chart which shows another example of a process flow in the first example of the present disclosure. In the example shown in FIG. 8, both the display device control section 117 and the error detection section 119 are included in the mobile phone 100, and the control signal reception section 213 is included in the mobile phone 200.

First, the display 209 displays an image, by the control of the display control section 207 of the mobile phone 200 (display device) (step S201). Two-dimensional codes 2001 and images 2003 are included in this image. On the other hand, the angle and focus are adjusted in the mobile phone 100 (display control apparatus), in a state in which the camera 101 projects the mobile phone 200 (display device) (step S203). More specifically, for example, the camera 101 adjusts the zoom so that the entire display 209 enters the angle of view as much as possible, performs trapezoid correction for a portion deviating from the front of the display 209, and adjusts the focus so that the two-dimensional codes 2001 and images 2003 are clearly projected.

When the adjustment of step S203 ends, the display device control section 117 of the mobile phone 100 transmits a start command of scrolling to the control signal reception section 213 of the mobile phone 200 (step S205). When the control signal reception section 213 receives the start command of scrolling in the mobile phone 200, the display control section 207 allows the image displayed on the display 209 to be scrolled (step S207). In this case, the display device control section 117 may specify the speed of scrolling, for example, in accordance with the performance of the camera 101, the interval of imaging, or the shutter speed. Or, the display device control section 117 may transmit information which shows the performance of the camera 101 to the control signal reception section 213 along with the start command, and the control signal reception section may determine the speed of scrolling in accordance with the performance of the camera 101.

The camera 101 performs imaging at prescribed intervals in the mobile phone 100, while a display of the display 209 is being scrolled (step S209). The image acquisition section 103 acquires the images captured at prescribed intervals by the camera 101. The display device control section 117 checks these captured images acquired by the image acquisition section 103 (step S211), and detects blurring or a deviation of focus, for example. In the case where these are detected, the display device control section 117 transmits an adjustment command of scrolling to the control signal reception section 213 (step S213). When the control signal reception section 213 receives the adjustment command of scrolling, the display control section 207 adjusts the scrolling of the display in accordance with the command (step S215). By an adjustment of scrolling by the steps S213 and S215, the speed of scrolling can becomes slower in the case where blurring occurs in the image, for example, and scrolling can start over for a section which is missing from the image or in which a deviation of focus has occurred.

When the display of one group of two-dimensional codes 2001 and images 2003 ends by scrolling (step S217), the end of scrolling may be notified from the mobile phone 200 to the mobile phone 100 (step S219). Or, the mobile phone 100 may recognize the end of scrolling, by a repetition of an approximately same image by captured images sequentially acquired by the camera 101, for example. When the end of scrolling is recognized, for example, by one of these methods (step S221), the image acquisition section 103 combines a series of acquired captured images (step S223), and provides the combined series of captured images to the URL extraction section 105 and the image extraction section 107. Up to the end of scrolling, the mobile phone 200 (display device) repeats scrolling of the image (step S207) and an adjustment of the scrolling (step S215), and the mobile phone 100 (image processing apparatus) repeats imaging (step S209), checking of the captured images (step S211), and transmission of a scrolling adjustment command (step S213).

Note that, for example, the process of the adjustment of scrolling of steps S211 to S215 in the above described process flow may not necessarily be executed. For example, checking of the captured images may be performed for the combined captured images after scrolling has ended and the captured images have been combined. In this case, in the case where there is a missing image, or blurring or a deviation of focus is detected in the combined captured images, the display device control section 117 may request that the display of images and scrolling be performed again to the mobile phone 200. Or, in the case where checking of the captured images is not performed, and the occurrence of a recognition error is detected by the error detection section 119 in the URL extraction section 105 or the image extraction section 107, the display device control section 117 may request that the display of images and scrolling be performed again to the mobile phone 200.

The above described first embodiment of the present disclosure is useful for various situations. An example in which images are shared between users will be described as an example of this.

Often photographs taken at an event (for example, a wedding ceremony or the like), at which many users who are mutual friends are gathered, are often exchanged between the users. At such a time, when images are desired to be exchanged immediately, the data amount to be exchanged increases as the number of photographs increases, and it takes time to recognize which photographs may be necessary. Accordingly, a substitution operation can be considered in which image files are uploaded to an online storage, and URLs are transmitted.

However, in this case, when a URL is exchanged immediately, it may be necessary to transmit this to a companion who is in one's presence as a message, for example, and this will take time. Further, it may be necessary for a new exchange of addresses to be performed in order to send a message, and there are cases where this is not desired in the sense of the dispersion of personal information. In addition, since it is difficult to comprehend which photograph is for which URL if only the URLs are received, it may take time to select photographs to be downloaded.

Accordingly, according to an application of the present embodiment, the side which provides photographs may allow only an image to be displayed, which includes two-dimensional codes 2001 in which the URLs of the online storage are embedded, and images 2003 which are thumbnails of the image files uploaded to the online storage, on the display 209 of the mobile phone 200. By only capturing images displayed on the display 209 with the camera of the mobile phone 100, the side which receives the photographs can access each of the image files, from an image which includes links 1001 and images 1003 displayed on the display 111 based on the captured images. Further, since a message may not be transmitted, unnecessary addresses are not exchanged.

In addition, since the images 1003 are displayed in association with the links 1001, what photographs are for which URLs can be recognized prior to accessing the image files, and desired photographs can be quickly downloaded. Further, if an image possessed by a user of the mobile phone 100 matches one of the images 1003, it is possible to automatically determine whether or not an image to be shared is the image already possessed by the user. Acquiring the images 1003 by capturing a displayed image 2003 takes less time and is simpler than receiving image files by communication.

### 4. Other Embodiments

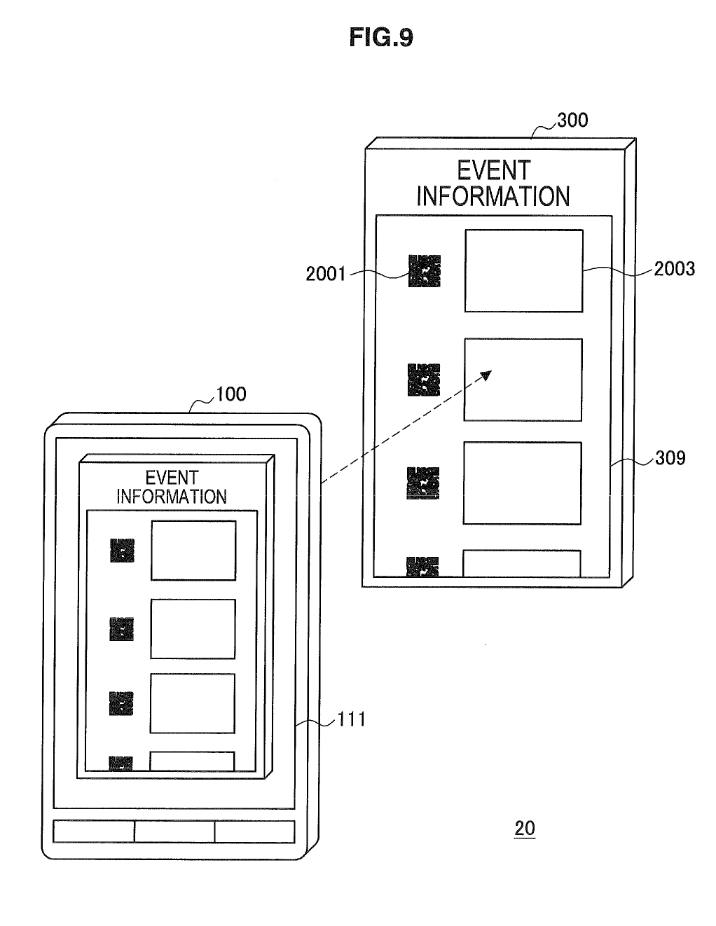

Next, other embodiments of the present disclosure will be described by referring to FIGS. 9 to 11.

FIG. 9 is a figure which shows a schematic configuration of a second embodiment of the present disclosure. With reference to FIG. 9, a system 20 includes a mobile phone 100 and a scrolling sign notifier 300. The mobile phone 100 includes a camera 101, and captures images which include an image displayed on a display 309 of the scrolling sign notifier 300. Two-dimensional codes 2001 and images 2003 are included in the image displayed on the display 309. The display 309 may allow the image to be scrolled by allowing the display to be electronically changed by a liquid crystal display, for example. Or, the display 309 may allow the image to be scrolled by allowing a curtain in which the image is drawn to be mechanically scrolled, for example.

In this way, a display device in an embodiment of the present disclosure (the scrolling sign notifier 300 in the present embodiment) may not necessarily be a device of the same type as that of an image processing apparatus, and may be another type of device. Further, the display device may not necessarily be a mobile device such as the mobile phone 200, and may be a stationary type device such as the scrolling sign notifier 300, for example. As described above, the display 309 may be either an electrical or mechanical display. Note that, in the example of FIG. 9, URLs for accessing webpages on which event information is published are embedded in the two-dimensional codes 2001, and the images 2003 are images which represent the event information.

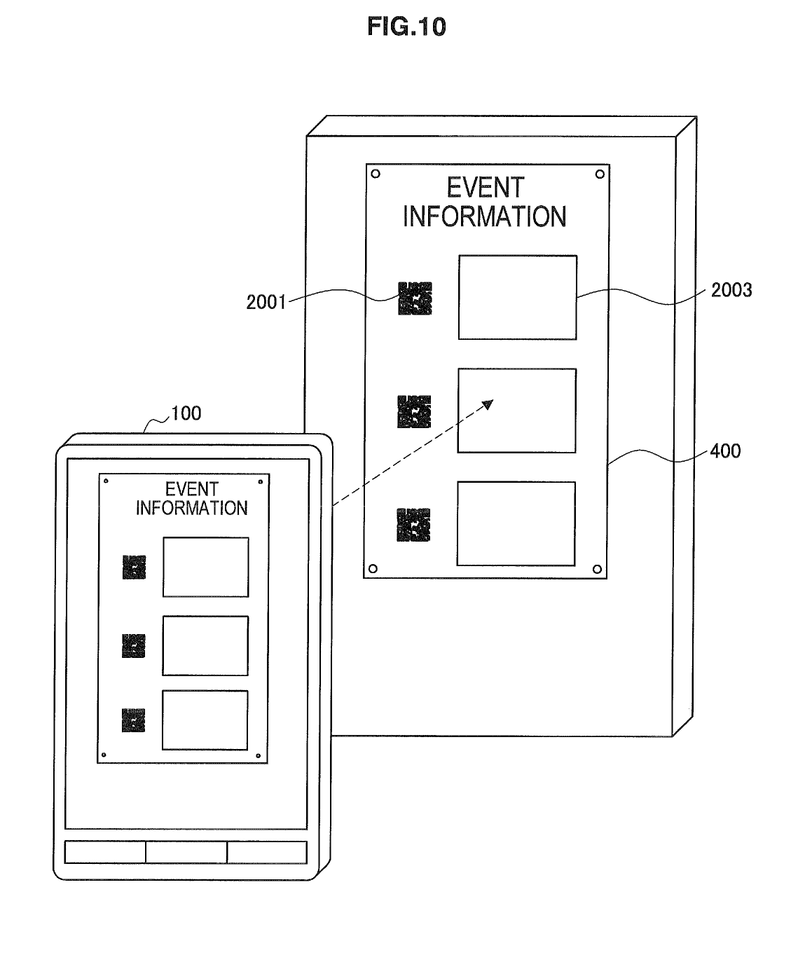

FIG. 10 is a figure which shows a schematic configuration of a third embodiment of the present disclosure. With reference to FIG. 10, the present embodiment relates to a mobile phone 100. The mobile phone 100 includes a camera 101, and captures images which include an image displayed on a poster 400 (a medium). Two-dimensional codes 2001 and images 2003 are included in the image displayed on the poster 400. In this way, the image processing apparatus according to an embodiment of the present disclosure is not limited to an image displayed on a display device, and may extract links 1001 and images 1003 from an image displayed on a medium. Note that, in the example of FIG. 10, URLs for accessing webpages on which event information is published are embedded in the two-dimensional codes 2001, and the images 2003 are images which represent the event information.

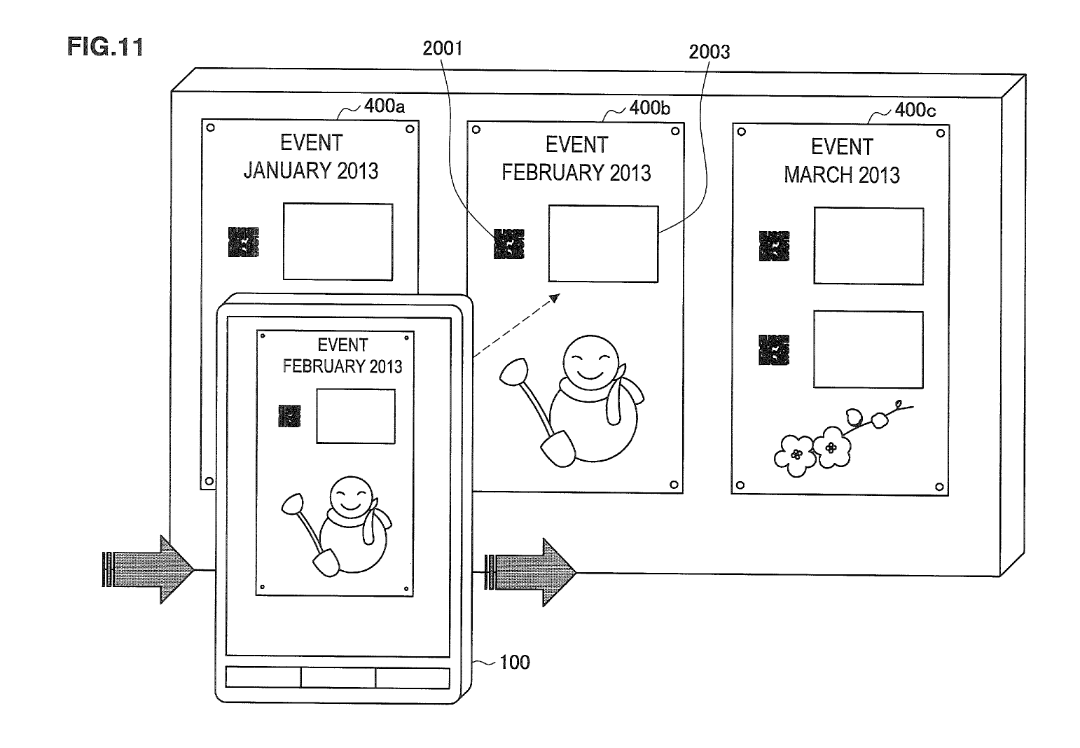

FIG. 11 is a figure which shows a schematic configuration of a fourth embodiment of the present disclosure. With reference to FIG. 11, the present embodiment relates to a mobile phone 100, and is the same as the above described third embodiment in that a camera 101 included in the mobile phone 100 captures images which include an image displayed on a poster 400. However, the present embodiment is different to the third embodiment in that the poster 400 is a plurality of posters 400a, 400b and 400c, and a group of one or a plurality of two-dimensional codes 2001 and images 2003 are included in each of the posters 400. Note that, in the example of FIG. 11, the poster 400a includes two-dimensional codes 2001 and images 2003 related to event information of January, the poster 400b includes two-dimensional codes 2001 and images 2003 related to event information of February, and the poster 400c includes two-dimensional codes 2001 and images 2003 related to event information of March.

In the illustrated example, it is difficult for the camera 101 of the mobile phone 100 to include all of the posters 400a to 400c within an angle of view, in a state in which the two-dimensional codes 2001 and images 2003 are capable of being extracted. Therefore, an imaging position is changed by allowing a user to move the mobile phone 100 along the wall on which the posters 400a to 400c are placed, while allowing imaging at prescribed intervals in the camera 101, and images which include the posters 400a, 400b and 400c are sequentially captured. As a result, images are captured similar to the case where an image is scrolled such as in the example shown in FIG. 4. Therefore, similar to the case where an image is scrolled, it is possible to extract URLs and images by combining a plurality of acquired captured images, and to exclude the URLs and images which are overlapping by extracting the URLs and images from each of the captured images.

Note that, it is possible to apply the various configuration examples shown in the above described first embodiment to the above described second embodiment. Further, it is possible to exclude the configuration which controls the display device, and to apply the various configuration examples of the first embodiment, to the third embodiment and the fourth embodiment.

While examples have been described in the above described embodiments in which the image processing apparatus is a mobile phone (a smart phone), the embodiments of the present disclosure are not limited to such examples. The image processing apparatus may be any type of apparatus which has a camera and a display, and may be, for example, a tablet type personal computer, a digital camera, a portable game machine, or the like. Or, the image processing apparatus may be implemented by one or a plurality a server apparatuses connected via a network to a terminal apparatus which has a camera and a display. In this case, an image acquisition section of an image processing apparatus acquires captured images from the terminal apparatus via the network, and a display control section controls a display of the display of the terminal apparatus via the network.

Further, the display device is also not limited to the mobile phone or the scrolling sign notifier described in the above described embodiments, and may be one of various types of apparatuses, such as one of various types of personal computers, a digital camera, a game machine, or a television. As described above, the display device may not necessarily be limited to a mobile device, and may be a stationary type device.

### 5. Hardware Configuration

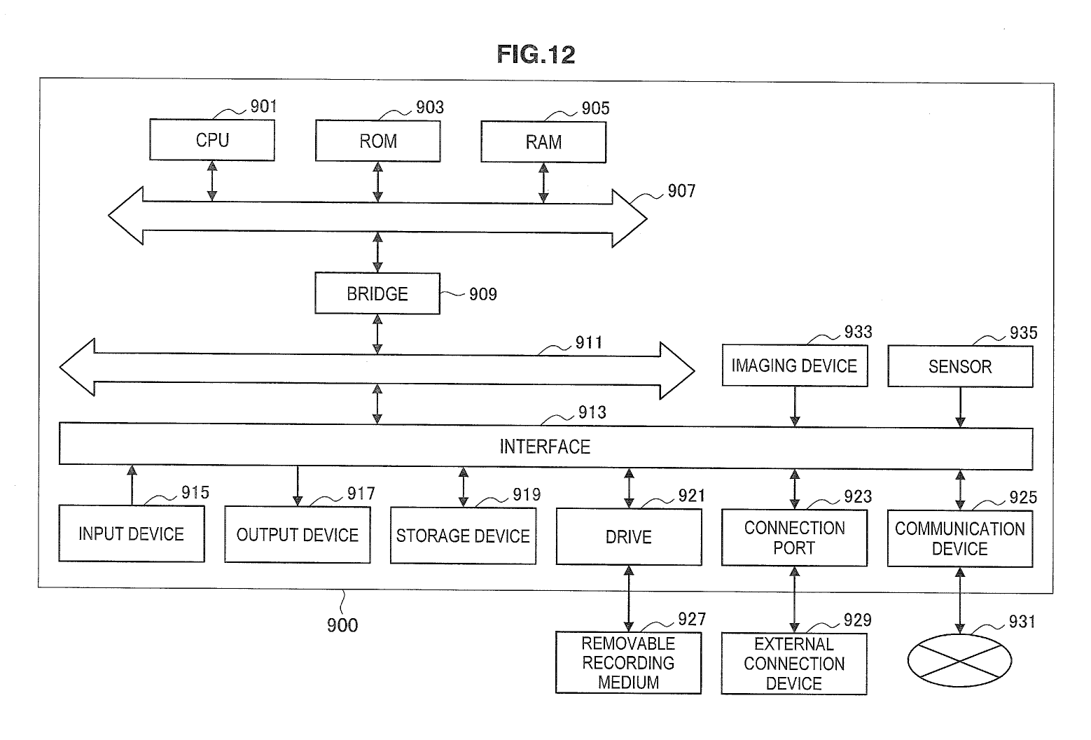

A hardware configuration of the information processing apparatus according to the embodiment of the present disclosure will be described with reference to FIG. 12. FIG. 12 is a block diagram for explaining a hardware configuration of the information processing device. The illustrated information processing device 900 may be implemented as a server device including the image processing apparatus and the display apparatus in the embodiments described above, for example.

The information processing apparatus 900 includes a CPU (Central Processing Unit) 901, a ROM (Read Only Memory) 903, and a RAM (Random Access Memory) 905. In addition, the information processing apparatus 900 may include a host bus 907, a bridge 909, an external bus 911, an interface 913, an input device 915, an output device 917, a storage device 919, a drive 921, a connection port 923, and a communication device 925. Further, the information processing apparatus 900 may include an imaging device 933 and a sensor 935 as necessary. The information processing apparatus 900 may include a processing circuit such as a DSP (Digital Signal Processor), alternatively or in addition to the CPU 901.

The CPU 901 serves as an operation processor and a controller, and controls all or some operations in the information processing apparatus 900 in accordance with various programs recorded in the ROM 903, the RAM 905, the storage device 919 or a removable recording medium 927. The ROM 903 stores programs and operation parameters which are used by the CPU 901. The RAM 905 primarily stores program which are used in the execution of the CPU 901 and parameters which is appropriately modified in the execution. The CPU 901, ROM 903, and RAM 905 are connected to each other by the host bus 907 configured to include an internal bus such as a CPU bus. In addition, the host bus 907 is connected to the external bus 911 such as a PCI (Peripheral Component Interconnect/Interface) bus via the bridge 909.

The input device 915 may be a device which is operated by a user, such as a mouse, a keyboard, a touch panel, buttons, switches and a lever. The input device 915 may be, for example, a remote control unit using infrared light or other radio waves, or may be an external connection device 929 such as a portable phone operable in response to the operation of the information processing apparatus 900. Furthermore, the input device 915 includes an input control circuit which generates an input signal on the basis of the information which is input by a user and outputs the input signal to the CPU 901. By operating the input device 915, a user can input various types of data to the information processing apparatus 900 or issue instructions for causing the information processing apparatus 900 to perform a processing operation.

The output device 917 includes a device capable of visually or audibly notifying the user of acquired information. The output device 917 may include a display device such as LCD (Liquid Crystal Display), PDP (Plasma Display Panel), and organic EL (Electro-Luminescence) displays, an audio output device such as speaker and headphone, and a peripheral device such as printer. The output device 917 may output the results obtained from the process of the information processing apparatus 900 in a form of a video such as text or image, and an audio such as voice or sound.

The storage device 919 is a device for data storage which is configured as an example of a storage unit of the information processing apparatus 900. The storage device 919 includes, for example, a magnetic storage device such as HDD (Hard Disk Drive), a semiconductor storage device, an optical storage device, or a magneto-optical storage device. The storage device 919 stores programs to be executed by the CPU 901, various data, and data obtained from the outside.

The drive 921 is a reader/writer for the removable recording medium 927 such as a magnetic disk, an optical disk, a magneto-optical disk, or a semiconductor memory, and is embedded in the information processing apparatus 900 or attached externally thereto. The drive 921 reads information recorded in the removable recording medium 927 attached thereto, and outputs the read information to the RAM 905. Further, the drive 921 can write in the removable recording medium 927 attached thereto.

The connection port 923 is a port used to directly connect devices to the information processing apparatus 900. The connection port 923 may include a USB (Universal Serial Bus) port, an IEEE1394 port, and a SCSI (Small Computer System Interface) port. The connection port 923 may further include an RS-232C port, an optical audio terminal, an HDMI (High-Definition Multimedia Interface) port, and so on. The connection of the external connection device 929 to the connection port 923 makes it possible to exchange various data between the information processing apparatus 900 and the external connection device 929.

The communication device 925 is, for example, a communication interface including a communication device or the like for connection to a communication network 931. The communication device 925 may be, for example, a communication card for a wired or wireless LAN (Local Area Network), Bluetooth (registered trademark), WUSB (Wireless USB) or the like. In addition, the communication device 925 may be a router for optical communication, a router for ADSL (Asymmetric Digital Subscriber Line), a modem for various kinds of communications, or the like. The communication device 925 can transmit and receive signals to and from, for example, the Internet or other communication devices based on a predetermined protocol such as TCP/IP. In addition, the communication network 931 connected to the communication device 925 may be a network or the like connected in a wired or wireless manner, and may be, for example, the Internet, a home LAN, infrared communication, radio wave communication, satellite communication, or the like.

The imaging device 933 is a device that generates an image by imaging a real space using an image sensor such as a charge-coupled device (CCD) or complementary metal-oxide-semiconductor (CMOS) sensor, as well as various members such as one or more lenses for controlling the formation of a subject image on the image sensor, for example. The imaging device 933 may be a device that takes still images, and may also be a device that takes moving images.

The sensor 935 is any of various sensors such as an acceleration sensor, a gyro sensor, a geomagnetic sensor, an optical sensor, or a sound sensor, for example. The sensor 935 acquires information regarding the state of the information processing apparatus 900, such as the orientation of the case of the information processing apparatus 900, as well as information regarding the environment surrounding the information processing apparatus 900, such as the brightness or noise surrounding the information processing apparatus 900, for example. The sensor 935 may also include a Global Positioning System (GPS) sensor that receives GPS signals and measures the latitude, longitude, and altitude of the apparatus.

The foregoing thus illustrates an exemplary hardware configuration of the information processing apparatus 900. Each of the above components may be realized using general-purpose members, but may also be realized in hardware specialized in the function of each component. Such a configuration may also be modified as appropriate according to the technological level at the time of the implementation.

### 6. Supplemental Remarks

Embodiments of the present disclosure encompass an image display apparatus, a display apparatus, or system, as described in the foregoing, a method executed by an image display apparatus, a display apparatus, or system, a program for causing an image display apparatus or a display apparatus to function, and a non-transitory tangible medium storing such a program, for example.

Additionally, the present technology may also be configured as below.

(1) An image processing apparatus including:

an image acquisition section configured to acquire a captured image including a plurality of two-dimensional codes and a plurality of images corresponding to each of the two-dimensional codes;

an address information extraction section configured to recognize each of the two-dimensional codes from the captured image, and to extract information showing addresses on a network from each of the two-dimensional codes;

an image extraction section configured to extract each of the images from the captured image; and

a display control section configured to allow a display section to display a link to each of the addresses in association with each of the images.

(2) The image processing apparatus according to (1),

wherein the image acquisition section acquires a plurality of captured images obtained by continuously imaging the display section on which the plurality of two-dimensional codes and the plurality of images are displayed while being scrolled.

(3) The image processing apparatus according to (2),

wherein the image acquisition section provides the plurality of captured images combined together to the address information extraction section and the image extraction section.

(4) The image processing apparatus according to (2),

wherein the image acquisition section provides the plurality of captured images to the address information extraction section and the image extraction section, and

wherein the address information extraction section and the image extraction section exclude the two-dimensional codes recognized from the plurality of captured images, or the extracted information showing addresses, and at least two images of the recognized images, the at least two images overlapping.

(5) The image processing apparatus according to any one of (1) to (4), further including:

a display device control section configured to communicate with a display device including the display section on which the plurality of two-dimensional codes and the plurality of images are displayed, and to control a display of the plurality of two-dimensional codes and the plurality of images in accordance with a state of the captured image or a recognition result of the two-dimensional codes or the images.

(6) The image processing apparatus according to (5),

wherein the image acquisition section acquires a plurality of captured images obtained by continuously imaging the display section on which the plurality of two-dimensional codes and the plurality of images are displayed while being scrolled, and

wherein the display device control section controls a speed or position of scrolling.

(7) The image processing apparatus according to any one of (1) to (6), further including:

an error detection section configured to detect that an error has occurred in recognition of each of the two-dimensional codes, extraction of the information showing addresses, or recognition of each of the images.

(8) The image processing apparatus according to (7), further including:

a display device control section configured to communicate with a display device including the display section on which the plurality of two-dimensional codes and the plurality of images are displayed, and to control a display of the two-dimensional codes and the plurality of images in accordance with a detection result of the error detection section.

(9) The image processing apparatus according to (7) or (8),

wherein the error detection section notifies a user that an error has occurred.

(10) The image processing apparatus according to any one of (7) to (9),

wherein the error detection section detects that an error has occurred, based on the recognized two-dimensional codes, the recognized images, or a number of the extracted information.

(11) The image processing apparatus according to (1),

wherein the image acquisition section acquires a captured image obtained by imaging one or a plurality of media on which the plurality of two-dimensional codes and the plurality of images have been drawn.

(12) The image processing apparatus according to (11),

wherein the image acquisition section acquires a plurality of captured images obtained by continuously imaging the one or plurality of media while allowing an imaging position to be moved.

(13) The image processing apparatus according to (12),

wherein the image acquisition section provides the plurality of captured images combined together to the address information extraction section and the image extraction section.

(14) The image processing apparatus according to (12),

wherein the image acquisition section provides the plurality of captured images to the address information extraction section and the image extraction section, and

wherein the address information extraction section and the image extraction section exclude the two-dimensional codes recognized from the plurality of captured images and at least two images of the images, the at least two images overlapping.

(15) The image processing apparatus according to any one of (1) to (14), further including:

an imaging section configured to provide an image to the image acquisition section; and

the display section.

(16) The image processing apparatus according to any one of (1) to (14),

wherein the image acquisition section acquires the captured image imaged by a terminal apparatus through communication with the terminal apparatus, and

wherein the display control section allows a display section of the terminal apparatus to display the link to each of the addresses in association with each of the images.

(17) An image processing method including:

acquiring a captured image including a plurality of two-dimensional codes and a plurality of images corresponding to each of the two-dimensional codes;

recognizing each of the two-dimensional codes from the captured image, and extracting information showing addresses on a network from each of the two-dimensional codes;

extracting each of the images from the captured image; and

allowing a display section to display a link to each of the addresses in association with each of the images.

(18) A program for causing a computer to execute the functions of:

acquiring a captured image including a plurality of two-dimensional codes and a plurality of images corresponding to each of the two-dimensional codes;

recognizing each of the two-dimensional codes from the captured image, and extracting information showing addresses on a network from each of the two-dimensional codes;

extracting each of the images from the captured image; and

allowing a display section to display a link to each of the addresses in association with each of the images.

(19) A display device including:

a display control section configured to allow a display section to display a plurality of two-dimensional codes in which information showing addresses on a network is embedded, and a plurality of images corresponding to each of the two-dimensional codes; and

a control signal reception section configured to receive, from an image processing apparatus which recognizes each of the two-dimensional codes and the images from a captured image including the plurality of two-dimensional codes and the plurality of images, a control signal sent in accordance with a state of the captured image or a recognition result of the two-dimensional codes or the images,

wherein the display control section controls a display of the plurality of two-dimensional codes and the plurality of images in accordance with the control signal.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
an image acquisition section configured to acquire a captured image including a plurality of two-dimensional codes and a plurality of images corresponding to each of the two-dimensional codes;
an address information extraction section configured to recognize each of the two-dimensional codes from the captured image, and to extract information showing addresses on a network from each of the two-dimensional codes;
an image extraction section configured to extract each of the images from the captured image; and
a display control section configured to allow a display section to display a link to each of the addresses in association with each of the images.

2. The image processing apparatus according to claim 1,
wherein the image acquisition section acquires a plurality of captured images obtained by continuously imaging the display section on which the plurality of two-dimensional codes and the plurality of images are displayed while being scrolled.

3. The image processing apparatus according to claim 2,
wherein the image acquisition section provides the plurality of captured images combined together to the address information extraction section and the image extraction section.

4. The image processing apparatus according to claim 2,
wherein the image acquisition section provides the plurality of captured images to the address information extraction section and the image extraction section, and
wherein the address information extraction section and the image extraction section exclude the two-dimensional codes recognized from the plurality of captured images, or the extracted information showing addresses, and at least two images of the recognized images, the at least two images overlapping.

5. The image processing apparatus according to claim 1, further comprising:
a display device control section configured to communicate with a display device including the display section on which the plurality of two-dimensional codes and the plurality of images are displayed, and to control a display of the plurality of two-dimensional codes and the plurality of images in accordance with a state of the captured image or a recognition result of the two-dimensional codes or the images.

6. The image processing apparatus according to claim 5,
wherein the image acquisition section acquires a plurality of captured images obtained by continuously imaging the display section on which the plurality of two-dimensional codes and the plurality of images are displayed while being scrolled, and
wherein the display device control section controls a speed or position of scrolling.

7. The image processing apparatus according to claim 1, further comprising:
an error detection section configured to detect that an error has occurred in recognition of each of the two-dimensional codes, extraction of the information showing addresses, or recognition of each of the images.

8. The image processing apparatus according to claim 7, further comprising:
a display device control section configured to communicate with a display device including the display section on which the plurality of two-dimensional codes and the plurality of images are displayed, and to control a display of the two-dimensional codes and the plurality of images in accordance with a detection result of the error detection section.

9. The image processing apparatus according to claim 7,
wherein the error detection section notifies a user that an error has occurred.

10. The image processing apparatus according to claim 7,
wherein the error detection section detects that an error has occurred, based on the recognized two-dimensional codes, the recognized images, or a number of the extracted information.

11. The image processing apparatus according to claim 1,
wherein the image acquisition section acquires a captured image obtained by imaging one or a plurality of media on which the plurality of two-dimensional codes and the plurality of images have been drawn.

12. The image processing apparatus according to claim 11,
wherein the image acquisition section acquires a plurality of captured images obtained by continuously imaging the one or plurality of media while allowing an imaging position to be moved.

13. The image processing apparatus according to claim 12,
wherein the image acquisition section provides the plurality of captured images combined together to the address information extraction section and the image extraction section.

14. The image processing apparatus according to claim 12,
wherein the image acquisition section provides the plurality of captured images to the address information extraction section and the image extraction section, and
wherein the address information extraction section and the image extraction section exclude the two-dimensional codes recognized from the plurality of captured images and at least two images of the images, the at least two images overlapping.

15. The image processing apparatus according to claim 1, further comprising:
an imaging section configured to provide an image to the image acquisition section; and
the display section.

16. The image processing apparatus according to claim 1,
wherein the image acquisition section acquires the captured image imaged by a terminal apparatus through communication with the terminal apparatus, and
wherein the display control section allows a display section of the terminal apparatus to display the link to each of the addresses in association with each of the images.

17. An image processing method comprising:
acquiring a captured image including a plurality of two-dimensional codes and a plurality of images corresponding to each of the two-dimensional codes;
recognizing each of the two-dimensional codes from the captured image, and extracting information showing addresses on a network from each of the two-dimensional codes;
extracting each of the images from the captured image; and
allowing a display section to display a link to each of the addresses in association with each of the images.

18. A program for causing a computer to execute the functions of:
acquiring a captured image including a plurality of two-dimensional codes and a plurality of images corresponding to each of the two-dimensional codes;
recognizing each of the two-dimensional codes from the captured image, and extracting information showing addresses on a network from each of the two-dimensional codes;
extracting each of the images from the captured image; and
allowing a display section to display a link to each of the addresses in association with each of the images.

19. A display device comprising:
a display control section configured to allow a display section to display a plurality of two-dimensional codes in which information showing addresses on a network is embedded, and a plurality of images corresponding to each of the two-dimensional codes; and
a control signal reception section configured to receive, from an image processing apparatus which recognizes each of the two-dimensional codes and the images from a captured image including the plurality of two-dimensional codes and the plurality of images, a control signal sent in accordance with a state of the captured image or a recognition result of the two-dimensional codes or the images,
wherein the display control section controls a display of the plurality of two-dimensional codes and the plurality of images in accordance with the control signal.
